(19) United States
(12) Patent Application Publication
(10) Pub. No.: US 2013/0086217 A1
(43) Pub. Date: Apr. 4, 2013

(54) SYSTEM AND METHOD FOR COMMUNICATING DATA VIA A WIRELESS HIGH SPEED LINK BETWEEN MOBILE COMPUTERS AND ARCHIVAL STORAGE DEVICES

(71) Applicants: William Pat Price, Rhome, TX (US); Gary WIlliam Streuter, Newport Beach, CA (US); James Siden, Newport Beach, CA (US); Ken Burke, Newport Beach, CA (US); Randy Dietz, Newport Beach, CA (US)

(72) Inventors: William Pat Price, Rhome, TX (US); Gary WIlliam Streuter, Newport Beach, CA (US); James Siden, Newport Beach, CA (US); Ken Burke, Newport Beach, CA (US); Randy Dietz, Newport Beach, CA (US)

(73) Assignee: CMS PRODUCTS INC, Costa Mesa, CA (US)

(21) Appl. No.: 13/686,274

(22) Filed: Nov. 27, 2012

Related U.S. Application Data
(63) Continuation of application No. 12/127,997, filed on May 28, 2008.

(51) Int. Cl. G06F 17/30

(52) U.S. Cl. CPC G06F 17/30073; H04L 67/06
USPC 709/217

(57) ABSTRACT

Desktop and portable computers to backup their data can backup their storage device over a wireless link where the storage device and the computer are always communicating whenever the link is established. Unlike existing technologies that provide wireless access between computers and storage devices the present invention does not require the storage device to be aware of operating systems or file system. All intelligence for file system access and how the data is archived resides with the desktop or portable computer.

This is a continuation of application Ser. No. 12,127,997, filed May 28, 2008, which claims priority based on provisional application number 60/941,236 filed May 31, 2007, the disclosure of which is herewith incorporated by reference.

### BACKGROUND

Data contained on computers is often more valuable than the computer or the storage device associated with the computer. As computers in business have proliferated from large centralized computers to relative inexpensive devices their numbers have increased to the point where most office workers have a computer on their desk. To one extent or another, most workers have become information creators. The information they create is often the life blood of a company and the value of the data normally exceeds the value of the computer itself to create the data.

Once a storage device fails, the data residing on it is usually lost. Over the previous 25 years, companies have tried various methodologies in an attempt to save their valuable data from loss. The methodologies have spawned whole industries devoted to the one task of archiving or backing up data from computers.

These efforts have had limited success at best. Early efforts in the field of backup required expensive peripheral storage devices and required a high cost of entry in terms of user knowledge and time. As the field of backing up data evolved, attempts were made to lower the knowledge required to backup data. Several products on the market only require a user press a button for a backup of their data to occur or only require that a user connect an external storage device to their computer to initiate a backup of their data. Literature in the field of backing up data would suggest that even these simple steps result in only a few percent of workers actually initiating backups.

Automated network backups are known in which backup is carried out to network storage devices with backup software in client computer systems attached to networks. Some of these may continuously back up the data, to avoid the user having to remember to initiate a backup. These systems fall short in that backing up to networks does not guarantee that a user can recover their individual data upon a catastrophic failure of the computer system.

### SUMMARY

Embodiments describe a system and technique which, once installed on the user's computer system, automatically handles all software backup.

With the device installed the user need only be in the vicinity of the backup storage device for the backup to take place. If the user's computer system hard disk drive fails, the user can remove the hard disk drive from their computer system and replace it with the hard disk drive from the wireless storage module; can restore all files from the wireless module, or can selectively transfer digital files from the wireless storage module to the computer system.

### BRIEF DESCRIPTION OF THE DRAWINGS

FIG. 1 depicts an embodiment in a configuration where the storage device and a wireless Transceiver are physically connected together.

FIG. 2 depicts the invention in a configuration where the storage device and a wireless Transceiver are integrated together in a single package.

### DETAILED DESCRIPTION

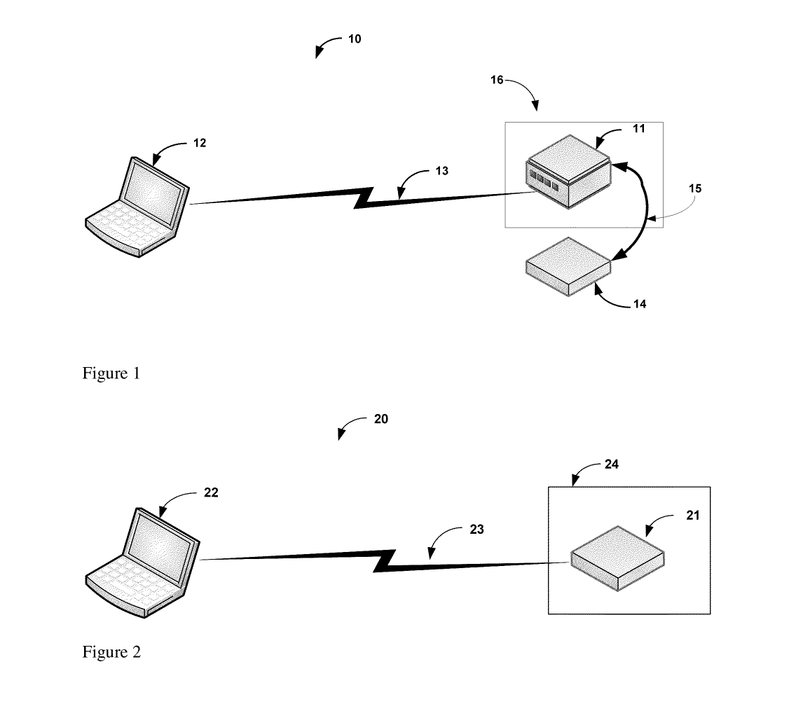

An embodiment of the present invention is depicted in FIG. 1. A system 10 includes a wireless link 13 which connects between a Computer System 12 and backup module 16. The module has a RF Transceiver 11, which can be a wireless Ethernet or Bluetooth transceiver. The RF Transceiver 11 and storage Device 14 are connected through Data Transfer Bus 15. RF Transceiver 11 preferably includes a power supply that controls its operation. FIG. 1 shows a configuration that is configured such that Storage Device 14 fits into the cradle or slot to allow physical connection between the storage device 14 and the transceiver 11. In an embodiment, Data Transfer Bus 15 is connected to RF Transceiver 11 and Storage Device 14 through a set of connectors. One connector connects Storage Device 14 and the other connects RF Transceiver 11 to the Data Transfer Bus 15. Data Transfer Bus 15 would typically be, but is not limited to, standard industry busses such as USB or IEEE 1394 or other network protocol.

FIG. 2 illustrates a second embodiment with said Module 24 representing an integrated package containing the said RF Transceiver, said Storage Device, and power supply. In this embodiment, the RF Transceiver and Storage Device contained inside Module 24 are connected together through a Data Transfer Bus where the connections to said RF Transceiver and said Storage Device are through traces or wires on a printed circuit board, and not through connectors normally specified for the Data Transfer Bus.

A software control Program in Computer System 12 manages the first RF Transceiver 11 to attempt to establish a link or coupling with said Second RF Transceiver using conventional connection software. If the link or coupling cannot be established, said Software Control Program periodically attempt the establishment of the link or coupling until such link or coupling is established. Once the link or coupling is established, said Software Control Program transfers a set of predefined digital files from said first Computer System 12 to said Module 16 and from said Module 16 to said Storage Device 14. Likewise, said Software Control Program can, under direction of the user, cause files contained on said Storage Device 14 to be transferred to first said Computer System 12 through said Module 16 and said RF Wireless Link 13.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other data formats, other kinds of scales, etc, may be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel e.g., Pentium or Core 2 duo or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage NAS, or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A radio frequency RF bi-directional digital data transfer system comprising:
a backup module comprising:
a storage unit,
a first software control program that executes on said backup module;
a backup server comprising:
a backup data storage unit,
a network coupled to said backup server and
a second software control program that executes on said backup ;
a communications link consisting of:
a first wireless access point coupled to said network and in communications with said backup server and
a first RF transceiver coupled to said backup module;
said first software control program configured to:
detect and connect to previously known wireless access points within range of said first RF transceiver and not to connect to unknown wireless access points within range of said first RF transceiver even if said wireless access points are not secured;
Said first software control program also configured such that:
when said first RF transceiver is connected to previously known wireless access points, said first software control program automatically backs up contents of said storage unit by sending information to said backup server when said known wireless access point is detected to be within range, but not to automatically backup contents of said storage unit by sending information to said backup server when said known wireless point is not detected to be within range.

2. The system of claim 1 where said backup server resides on a local area network.

3. The system of claim 1 where said backup server resides on the internet.

4. A radio frequency bi-directional digital data transfer system comprising:
a first computer comprising:
a first RF transceiver,
a first internal data storage device and
a first software control program;
a wireless access point;
a backup server residing on a network comprising:
a backup data storage device and
a second software control program;
said backup server in communications with said wireless access point over said network;
said first software control program configured to:
detect and connect to a previously known wireless access point via said first RF transceiver when said previously known wireless access point is within range of said first RF transceiver, and not attempt to connect to any other wireless access point even if said other wireless access point not secured and is within range of said first RF transceiver;
said second software control program configured to:
manage a communications link between said first computer and said backup server via said first RF transceiver and said previously known wireless access point and to manage a file system resident on said backup data storage device;
once said first software control program detects that said previously known wireless access point is within range of said first RF transceiver:
said first software control program will automatically backup contents of said first internal data storage device or will resume a previous backup that was terminated by a previous loss of said communications link by sending information to said backup server but not attempt to automatically backup contents of said storage unit by sending information to said backup server when said previously known wireless access point is not detected to be within range.

5. The computer as in claim 2 where:
a first external bus connects a first external data storage device to said computer and,
said first software program will detect when said previously known wireless access point is within range of said first RF transceiver and,
said first software control program will automatically backup contents of said first external data storage device or will resume a previous backup that was terminated by a previous loss of said communications link by sending information to said backup server but not attempt to automatically backup contents of said first external data storage device by sending information to said backup server when said previously known wireless access point is not detected to be within range.

6. A method for wirelessly backing up data from a computer system to a backup server on a network comprising the steps of:
automatically detecting a remote storage unit through a communications link between a RF transceiver coupled to said computer system and a previously known wireless access point;
establishing a wireless connection with said remote storage unit by detecting wirelessly when the remote storage unit is present and otherwise not attempting to establish the wireless connection with the remote storage unit when the remote storage unit is not detected to be present and providing responses to challenges from said remote storage unit if said remote storage unit requests responses to permit access to said remote storage unit by said computer;
automatically sending information indicative of files on said computer to said remote storage unit only when said remote storage unit is detected to be present and has granted access to said computer;
when all information indicative of files on said computer has been sent to said remote storage unit, informing said remote storage unit that a backup session is complete and said communications link is terminated.

7. A method for wirelessly backing up data from a computer system to a backup server on a network comprising the steps of:
automatically detecting a remote storage unit through a communications link between a RF transceiver coupled to said computer system and a previously known wireless access point;
establishing a wireless connection with said remote storage unit by detecting wirelessly when the remote storage unit is present and otherwise not attempting to establish the wireless connection with the remote storage unit when the remote storage unit is not detected to be present and providing responses to challenges from said remote storage unit if said remote storage unit requests responses to permit access to said remote storage unit by said computer;
automatically sending information indicative of files on said computer to said remote storage unit only when said remote storage unit is detected to be present and has granted access to said computer;
when the information indicative of a predetermined number of files on said computer has been sent to said remote storage unit, informing said remote storage unit that the current backup session is complete and said communications link is terminated.

8. A method for wirelessly backing up data from a computer system to a backup server on a network comprising the steps of:
automatically detecting a remote storage unit through a communications link between a RF transceiver coupled to said computer system and a previously known wireless access point;
establishing a wireless connection with said remote storage unit by detecting wirelessly when the remote storage unit is present and otherwise not attempting to establish the wireless connection with the remote storage unit when the remote storage unit is not detected to be present and providing responses to challenges from said remote storage unit if said remote storage unit requests responses to permit access to said remote storage unit by said computer;
automatically sending information indicative of files on said computer to said remote storage unit only when said remote storage unit is detected to be present and has granted access to said computer;
when the information indicative of a predetermined number of files on said computer have been sent to said remote storage unit, informing said remote storage unit that the current backup session is complete and said communications link is terminated after which, said communications link is reestablished and a subsequent backup session is initiated.
